(19) United States
(12) Patent Application Publication
(10) Pub. No.: US 2012/0244315 A1
(43) Pub. Date: Sep. 27, 2012

(54) TARPAULIN HAVING SIMULATED ROOFING SURFACE

(75) Inventor: Peter J. Barrego, Newport, RI (US)

(73) Assignee: PrimeSource Building Products, Inc., Carrollton, TX (US)

(21) Appl. No.: 13/052,212

(22) Filed: Mar. 21, 2011

(51) Int. Cl. B32B 3/10; B32B 5/02

(52) U.S. Cl. 428/141; 442/181; 428/195.1

(57) ABSTRACT

A tarpaulin includes a plurality of warp strands and a plurality of weft strands, a protective weatherproof coating, and simulated roofing surface. The warp and weft strands are woven into a weave pattern to form a mesh substrate. The protective weatherproof coating may include one or more pigments, an ultraviolet stabilizer, flame retardants, and other fillers that protect the mesh substrate from exposure to various conditions. A simulated roofing surface is applied to the protective weatherproof coating by printing or like means. This simulated roofing surface can have the appearance of roofing materials such as shingles, shakes, or tiles.

### BACKGROUND OF THE INVENTION

1. Field of the Invention

The field of the present invention is tarpaulins, particularly tarpaulins having a simulated roofing surface.

2. Background

Using a conventional tarpaulin to cover unfinished or damaged roofs presents numerous problems for building owners. Although tarpaulins can prevent deterioration, limit roofing damage, protect valuables, etc., they are unsightly. The appearance of conventional tarpaulins in a neighborhood connotes damage—roofing and aesthetic—to the neighborhood.

Manufacturers of conventional tarpaulins primarily use solid hues of bright blue and green. One example of such an unadorned tarpaulin used to cover a damaged roof is described in U.S. Pat. No. 7,299,588. These types of tarpaulins stand out and bring unnecessary, unwanted attention to a neighborhood. When exposed areas result from severe weather, e.g. hurricanes and tornadoes, often the roofs of entire neighborhoods are covered with blue tarpaulins. While in place, these blue tarpaulins can be a continuing reminder of death, destruction, and sometimes the continuing decline of property values, especially in hurricane and tornado prone areas.

During the time tarpaulins are temporarily in place, building owners need to select the best options for repair. In some cases, this will mean replacing a portion of a roof or selecting an entirely new roof. While roofing materials are available in a variety of shades and styles, owners who are replacing only a portion must use conventional tarpaulins to cover exposed areas. Many of these owners would likely prefer to use tarpaulin materials that bring less attention to exposed areas. In addition, owners who choose to replace an entire roof may find it difficult to assess how certain colors, finishes, and styles will appear.

Considering the lack of aesthetic value provided by conventional tarpaulins and the limited options available to building owners, choosing to repair or replace roofing materials, a clear need exists for improved tarpaulins.

### SUMMARY OF THE INVENTION

The present invention is directed toward tarpaulins, particularly tarpaulins having a simulated roofing surface. Tarpaulins with surfaces that simulate other structural components are also contemplated.

In one aspect, the tarpaulin includes a plurality of warp strands and a plurality of weft strands, a protective weatherproof coating, impregnating and covering the strands, and a simulated roofing surface, printed on at least one surface of the tarpaulin. The warp and weft strands are woven into a weave pattern to form a mesh substrate. Once formed, a protective weatherproof coating is applied to the mesh substrate. The coating can include one or more pigments, an ultraviolet stabilizer, flame retardants, and other fillers that protect the mesh substrate from exposure to various conditions.

A simulated roofing surface is applied to the protective coating. The simulated roofing surface can have the appearance of roofing materials such as shingles, shakes, and tiles of various shapes, colors, finishes, and configurations.

Accordingly, an improved tarpaulin is disclosed. Advantages of the improvements will appear from the drawings and following description.

### BRIEF DESCRIPTION OF THE DRAWINGS

FIG. 1 is a partial top view of a tarpaulin, including a partial view of a protective weatherproof coating over a mesh substrate;

FIG. 2 is a cross-sectional view of a tarpaulin taken along line 2-2 of FIG. 1;

FIG. 3 illustrates a tarpaulin installed on a roof, having a simulated roofing surface;

FIG. 4 illustrates a tarpaulin installed on a roof, having a second simulated roofing surface; and

FIG. 5 is a schematic diagram of a phase of tarpaulin manufacture.

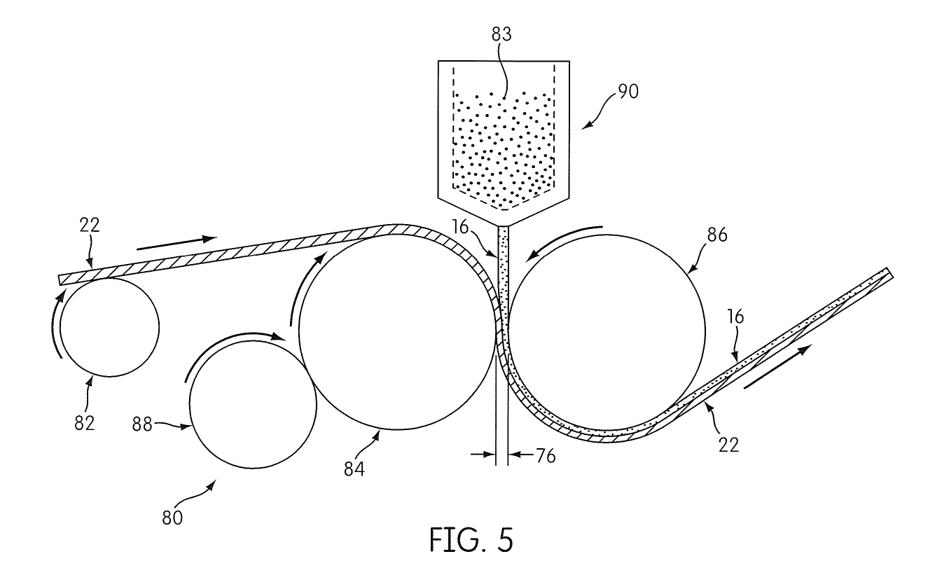

### DETAILED DESCRIPTION

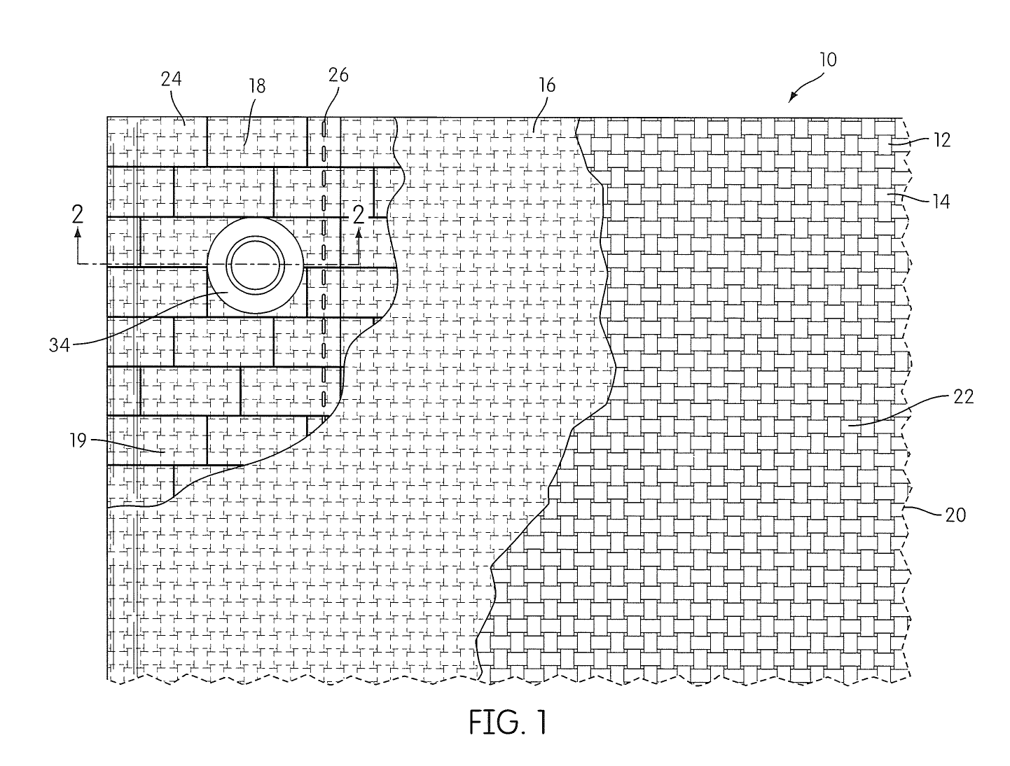

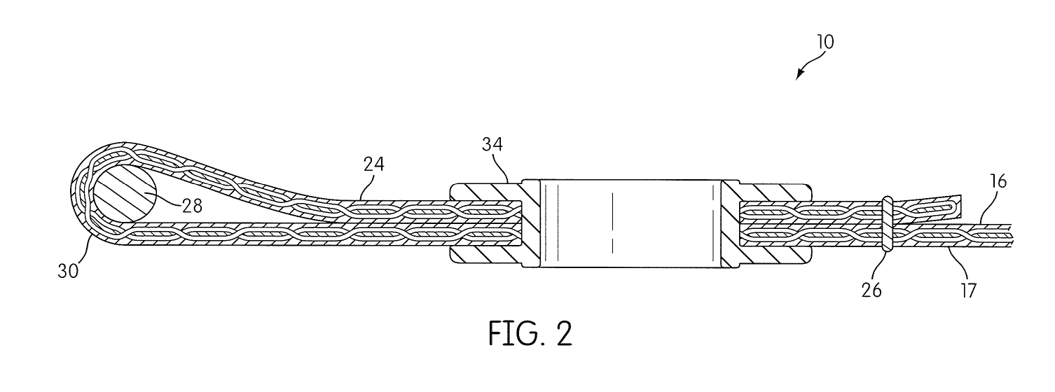

Turning in detail to the drawings, FIGS. 1-4 illustrate a tarpaulin 10. As shown, particularly in FIGS. 1 and 2, the tarpaulin 10 includes a plurality of warp strands 12 and a plurality of weft strands 14, a protective weatherproof coating 16, and a simulated roofing surface 18 having one or more patterns 19.

The tarpaulin 10 is preferably lightweight but strong, due to the interwoven, cross-directional configuration of strands 12, 14. Once properly installed, the tarpaulin is adapted to temporarily protect exposed areas on a structure—usually for a period not longer than about three to six months. The tarpaulin, as described herein, is a covering designed for temporary—not permanent—coverage, particularly for exposed areas on a structure. Exposed areas can result from, among other things, improper installation, poor maintenance, mold, mildew, and various weather conditions, including hurricanes and tornadoes.

In its finished state, the tarpaulin 10 has a thickness ranging from about 0.005 inches to about 0.010 inches, depending upon whether the tarpaulin is designated as light duty, medium duty, or heavy duty. Light duty tarpaulins have an overall thickness ranging from about 0.005 inches to 0.006 inches. Medium duty tarpaulins have an overall thickness ranging from about 0.0075 inches to 0.0085 inches. And, heavy duty tarpaulins have an overall thickness ranging from about 0.0085 inches to 0.0010 inches.

Moreover, in its finished state, the tarpaulin 10 is preferably provided as a rectangular or square sheet. The tarpaulin may, however, be manufactured in any shape, including ovals, circles, and triangles. Sheet sizes typically have a width ranging from about 5 feet to about 50 feet and a length ranging from about 7 feet to about 100 feet.

As shown in FIG. 1, the tarpaulin 10 includes warp strands 12 and weft strands 14. In one configuration, the warp strands 12 and the weft strands 14 are both manufactured from high density polyethylene (HDPE), having a strength of 3.5 gf/denier. Both the weft strands and the warp strands are preferably made in widths ranging from about ⅛ inch to about ¼ inch.

The warp strands 12 and the weft strands 14 are woven into a weave pattern 20 that provides multidirectional strength to the tarpaulin 10. The weave pattern 20 forms a mesh substrate 22. The strands are interwoven into a mesh substrate ranging from about 5 feet×7 feet to about 50 feet×100 feet. Although a plain weave pattern is shown in FIG. 1, any other weave pattern providing multidirectional strength is suitable.

Once formed, the mesh substrate 22 is coated on at least one side with a protective weatherproof coating 16. The protective weatherproof coating 16 can include one or more pigments, an ultraviolet stabilizer, flame retardants, and other fillers that protect the mesh substrate from exposure to various conditions. In one configuration, the protective weatherproof coating 16 includes low density polyethylene (LDPE) as a major component. Preferably, the protective weatherproof coating 16 is extruded such that it impregnates the mesh substrate.

As shown in FIG. 7, one phase of tarpaulin manufacture includes the use of a calender 80 and extruder 90. The calender 80 uses rotating press and die rollers of various sizes and materials. In one configuration, the mesh substrate 22 is placed on one or more intake rollers 82. An intake roller 82 is then used to move the mesh substrate 22 onto a press roller 84. One or more additional rollers 88 may be used to facilitate rotation of the press roller 84. Mixed components 83 of the protective weatherproof coating 16 are placed in the extruder 90 and then exit the extruder at a predetermined rate and thickness. Concurrently, the mesh substrate 22 and the coating enter a nip area 76 between the press roller 84 and a die roller 86. Preferably, the press roller is made of an elastomeric material and the die roller is made from a metallic material such as steel. Other materials for the press and die rollers, however, may be suitable, depending upon the composition and properties of the mesh substrate and the coating.

Under preferred conditions, the protective weatherproof coating 16 is extruded under heat such that it partially melts over one side of the mesh substrate 22. In addition, under preferred conditions, the die roller has a temperature significantly lower than that of the extruded coating as it exits the extruder, such that the coating is cooled.

As the coating 16 and the mesh substrate 22 pass through nip 76 between the press roller 84 and the die roller 86, the materials are compressed. This compression allows the protective weatherproof coating 16 to impregnate and attach itself to the mesh substrate 22. This process may then be repeated to coat the opposite side of the mesh substrate to form a second coating layer 17 (shown in FIG. 2).

Pigments included in the protective weatherproof coating can produce a coating of any color or finish.

An ultraviolet stabilizer is also preferably a component of the protective weatherproof coating 16. In one configuration, the ultraviolet stabilizer is manufactured using a mixture of TINUVIN 784 UV powder and a flame retardant, among other fillers. Before extrusion and application of the coating, a master batch is made using the UV powder. In the master batch, the UV powder preferably does not exceed 0.5% of the total coating weight. In addition to the UV powder, the protective weatherproof coating can contain a flame retardant made from Bromine+Sb₂O₃ or other suitable flame retardant composition in compliance with recommended standards. In one type of coating composition, the flame retardant does not exceed about 8% of the overall coating weight. In addition to the pigments, UV stabilizer and the flame retardants described, the protective weatherproof coating can include other types of fillers that protect the mesh substrate from exposure to various conditions.

As shown in FIG. 2, in addition to the protective weatherproof coating 16, a second coating layer 17 may be applied. The second coating layer 17 may have the same composition as protective weatherproof coating 16. However, the second coating layer 17 may be provided with additional fillers and additives or simulate a second type of roofing surface, providing additional options for building owners, particularly those who are replacing a roof in its entirety.

After application of the coating(s) to the mesh substrate, a simulated roofing surface 18 is applied. This simulated roofing surface 18 can have the appearance of roofing materials such shingles, shakes, and tiles of various shapes, colors, finishes and configurations. Such tile types include, but are not limited to, Spanish tile, mission tile, barrel tile, straight tile, tapered tile, Roman tile, English tile, Shingle tile, and French tile. Roofing material shapes, in particular, can include bevel, scallop, pointed, rectangular, fish scale, and square.

In addition, the simulated roofing surface may have one or more patterns 19, depending upon the needs of the building owner. These patterns 19 may differ, depending on the style of roofing materials used from region to region. Further, the finish of the simulated roofing surface can vary. Types of finishes can include metallic, asphalt, concrete, slate, clay, rubber, copper, ceramic, wood, plastic, or a combination of finishes.

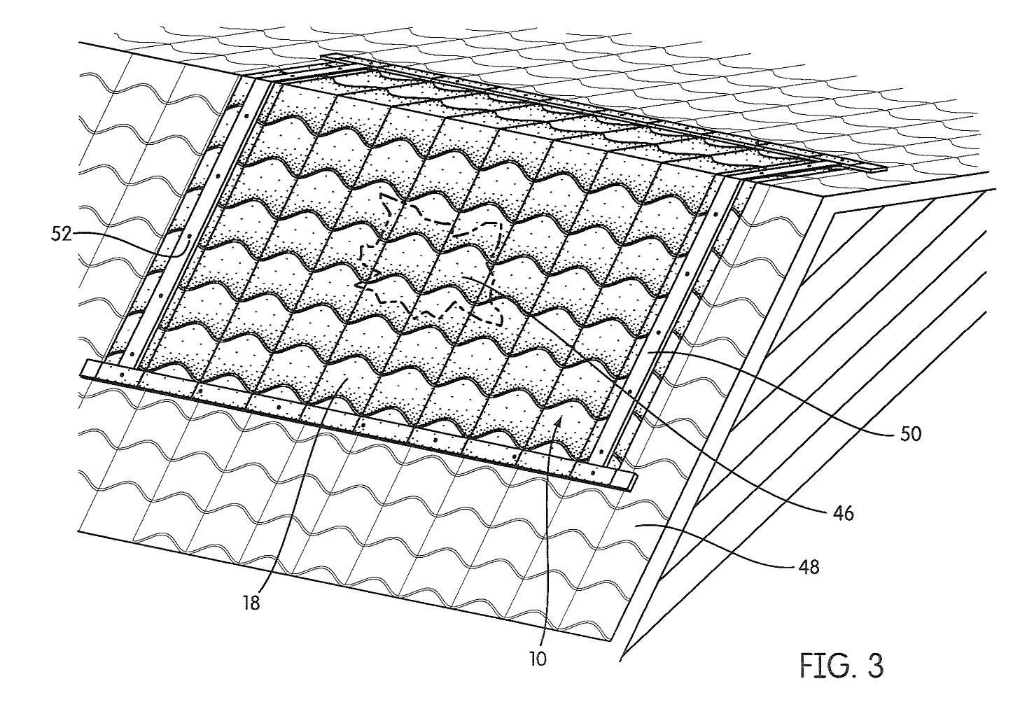

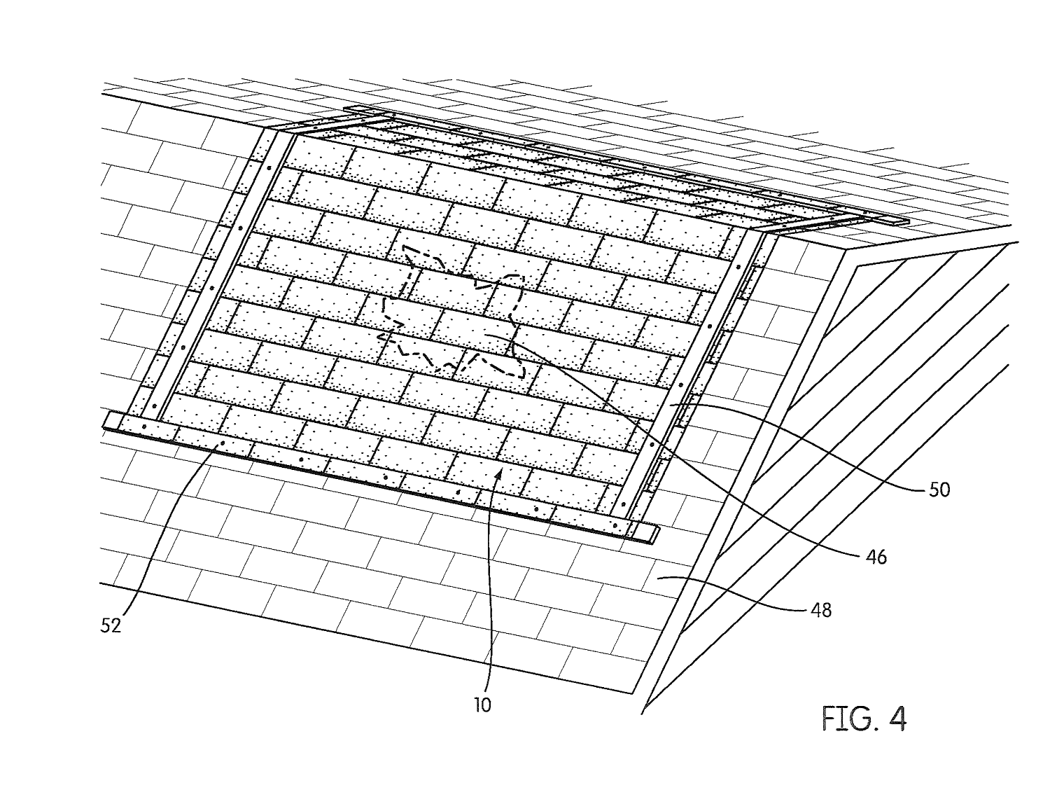

The simulated roofing surface 18 can also be designed to simulate the appearance of any roofing material such that the tarpaulin blends with surrounding materials, thereby avoiding unnecessary attention brought by conventional tarpaulins, as shown in FIGS. 3 and 4.

While the simulated roofing surface may be produced using any acceptable method, printing methods such as rotogravure and flexographic printing are preferred. The selection of the production method will depend, in part, on the continuity and complexity of the selected pattern or patterns. Other production methods include staining, dyeing, and painting the coating layer.

Regardless of the production process used for the simulated roofing surface, it preferably has properties that lend for easy application and installation of the tarpaulin. For example, when a printing process is used, inks containing additives that provide additional roof protection and installation benefits are preferred. Particularly, the simulated roofing surface 18 may be printed with inks having non-skid properties. These types of inks help prevent slipping by persons who must navigate across tarpaulins during and after installation. Also, preferably, the ink will contain a UV stabilizer that prevents deterioration due to sun exposure. Moreover, the simulated roofing surface 18 preferably has a matte finish that limits glare.

In the rotogravure printing process, the first step is image preparation. A roofing pattern or image is supplied from a photograph or other reproduction method. The chosen image is then engraved intaglio onto a printing cylinder which is copper coated. The engraved copper coated sections preferably include an additional coating of chrome.

During the rotogravure printing process, the tarpaulin is disposed between a press roller (not shown), having elastomeric sheathing, and the printing cylinder. The printing cylinder is further coupled to a dipping cylinder which retrieves ink from a reservoir. Preferably, the dipping cylinder is disposed under the printing cylinder. As the tarpaulin travels, the printing cylinder transfers the image onto the protective weather proof coating, creating a simulated roofing surface. Optionally, as the printing cylinder rotates, a cutting tool is used to remove excess ink from the surface of the printing cylinder. Generally, the rotogravure printing process is used for continuous roofing patterns.

In the flexographic printing process, the first step is also image preparation. In preparing the simulated roofing surface, one or more roofing patterns or images are supplied from a photograph or other type of reproduction method. The selected image is engraved onto one or more plates, preferably manufactured from an elastomeric material. These plates are further coupled to a printing cylinder.

During the flexographic printing process, the tarpaulin is disposed between a press roller, preferably manufactured from steel, and the printing cylinder. As the printing cylinder rotates, it retrieves ink from a reservoir. As the tarpaulin travels, the printing cylinder transfers the image onto the protective weather proof coating, creating a simulated roofing surface.

The printing process produces a simulated roofing surface 18, as shown particularly in FIGS. 3 and 4. The simulated roofing surface 18 can, therefore, mimic shingles, shakes, or tiles made from asphalt, wood, concrete, metal, or a combination of these and other types of materials.

The tarpaulin 10 may also be provided with a hem 24, as shown in FIGS. 1 and 2. Preferably, the hem 24 is produced by folding over a portion of the tarpaulin. The hem 24 is then held in place with stitching 26. Other methods of holding the hem in place may, however, be used. Such methods include heat welding and adhesive application. The hem 24 can extend around the entire perimeter of the tarpaulin or a portion of the perimeter.

Preferably contained within the hem is a reinforcement 28. In one configuration, the reinforcement 28 is a rope; however, other means of reinforcement may be used. The reinforcement 28 serves to reinforce the edges 30 of the tarpaulin 10. In addition, where the tarpaulin is configured with corners, a second reinforcement 32 (not shown) may be provided. In one configuration, the second reinforcement is a patch of material that is incorporated into the hem. The second reinforcement 32 may have a triangular shape or other configuration that allows for insertion into a corner or other area.

Preferably, grommets 34 are included as part of the hem 24. The grommets are designed such that a tarpaulin may be secured to a roof 36 or other roofing surface. The grommets may be manufactured from any material, including, but not limited to, plastic, aluminum, brass, and steel. The grommets 34 are preferably disposed within the hem at predetermined intervals, depending upon the length and width of the tarpaulin 10. For example, the grommets may be disposed at equal intervals of 1 foot, 2 feet or 3 feet.

As shown in FIGS. 3 and 4, after the tarpaulin 10 is unrolled or unfolded, it is covered taut over an exposed or damaged area 46 on the roofing surface 48 such that water and debris will not collect or enter. The tarpaulin 10 having a simulated roofing surface 18 may be held in place using wood strips 50, e.g. 2×4 wood strips. One end of the tarpaulin 10 is wrapped around the wood strip and positioned in place using fasteners 52. The simulated roofing surface 18 can have the appearance of various types of roofing elements.

While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A tarpaulin comprising:
a plurality of warp strands woven with a plurality of weft strands;
a protective weatherproof coating disposed over the plurality of warp strands and the plurality of weft strands; and
a simulated roofing surface disposed onto the protective weatherproof coating.

2. The tarpaulin of claim 1, wherein the plurality of warp strands is high density polyethylene.

3. The tarpaulin of claim 1, wherein the plurality of weft strands is high density polyethylene.

4. The tarpaulin of claim 1, wherein the protective weatherproof coating comprises low density polyethylene.

5. The tarpaulin of claim 1, wherein the protective weatherproof coating has at least one pigment.

6. The tarpaulin of claim 1, wherein the protective weatherproof coating has an ultra-violet stabilizer.

7. The tarpaulin of claim 1, wherein the simulated roofing surface has a tile-like appearance.

8. The tarpaulin of claim 7, wherein the tile-like appearance is selected from the group consisting of Spanish tile, mission tile, barrel tile, straight tile, tapered tile, Roman tile, English tile, shingle tile, and French tile.

9. The tarpaulin of claim 1, wherein the simulated roofing surface has a shingle-like appearance.

10. The tarpaulin of claim 1, wherein the simulated roofing surface has a shake-like appearance.

11. The tarpaulin of claim 1, wherein the simulated roofing surface has a finish selected from the group consisting of metallic, asphalt, concrete, slate, clay, rubber, copper, brick, ceramic, and wood.

12. The tarpaulin of claim 1, wherein the simulated roofing surface is printed.

13. The tarpaulin of claim 1, wherein the simulated roofing surface is printed using a rotogravure printing process.

14. The tarpaulin of claim 1, wherein the simulated roofing surface is printed using a flexographic printing process.
